(19) United States
(12) Patent Application Publication
(10) Pub. No.: US 2015/0348138 A1
(43) Pub. Date: Dec. 3, 2015

(54) DEVICE AND METHOD FOR MANAGING EXPOSURE ORDER OF ADVERTISEMENT LINKED TO LOCATION OF CLIENT

(71) Applicant: Soo-Hyun KIM, (US)

(72) Inventor: Soo-Hyun KIM, Daejeon (KR)

(21) Appl. No.: 14/401,994

(22) PCT Filed: Oct. 22, 2012
(86) PCT No.: PCT/KR2012/008668

§ 371 Date: Nov. 18, 2014

(30) Foreign Application Priority Data
Jul. 26, 2012 (KR) 10-2012-0081637

(51) Int. Cl. G06Q 30/02

(52) U.S. Cl. CPC G06Q 30/0275; G06Q 30/0259

(57) ABSTRACT

Provided is a device and method for managing the exposure order of an advertisement linked to the location of a client. Since a distance-bidding device which exposes an advertisement provided by an advertiser to a connected client adds a bid-based advertisement ranking determined in order of advertisement unit price by bidding for the advertisement received from the advertiser to a distance-based advertisement ranking determined on the basis of a position of the connected client such as a wired or wireless computer, a cellular phone, a smart phone, an IPTV, a set-top box, various terminals or the like, even an advertiser of a low bidding advertisement ranking may place an advertisement in a specific region

### BACKGROUND

The present invention relates to a device and method for managing an exposure ranking of an advertisement combined with a position of a client, which can place an advertisement reasonable for an advertiser by adding a bid-based advertisement ranking determined in order of advertisement unit price by bidding to a distance-based advertisement ranking determined on the basis of a position of a connected client.

Online sales of products through the Internet, as well as classical sales of products through offline, abruptly increase.

In order to sell a lot of products through the Internet, a seller should publicize his or her site to general users through an aggressive marketing method such as an advertisement or the like. Accordingly, a marketing strategy such as placing an advertisement on a variety of portal sites or the like is needed.

Meanwhile, a portal site or the like acting as an adverting agency sells keywords for advertisement in order to increase advertisement income, and if advertisers offer a bidding price for a keyword, a top priority is set to an advertisement of an advertiser offering the highest bidding price, and when general consumers perform a search using the keyword as a search keyword word, a result of the search is listed according to rankings of the bidding prices of the advertisers.

Since such an advertisement set by the bidding price is exposed according to a specific keyword regardless of a position of a connected client, a region of the advertisement is vast, and thus an advertiser of a small business may not afford the bidding price.

Although a method of advertising by confirming a position of a connected client is used in the prior art to solve the problem, since only local advertisements are exposed to the clients in this method, an advertiser who desires to advertise in a broad region may not place an advertisement.

### SUMMARY OF THE INVENTION

Therefore, the present invention has been made in view of the above problems, and it is an object of the present invention to provide a device and method for managing an exposure ranking of an advertisement combined with a position of a client, which can place an advertisement reasonable for an advertiser by adding a bid-based advertisement ranking determined in order of advertisement unit price by bidding to a distance-based advertisement ranking determined on the basis of a position of a connected client.

Another object of the present invention is to provide a device and method for managing an exposure ranking of an advertisement combined with a position of a client, in which since a bid-based advertisement ranking according to bidding and a distance-based advertisement ranking according to a distance are combined, although the bid-based advertisement ranking of an advertisement is low, the advertisement can be exposed to a client at a high priority in a specific region.

To accomplish the above objects, according to one aspect of the present invention, there is provided a device for managing an exposure ranking of an advertisement combined with a position of a client, the device including: an advertiser management module 202 for receiving information on registration of an advertiser who desires to place an advertisement to a client 100 connected in a wired or wireless manner and storing and managing the information in an advertiser DB (220; an advertisement registration module 204 for receiving information on a region of advertisement and content of the advertisement from the advertiser and storing and managing the information in an advertisement DB 222; a bid-based advertisement ranking management module 206 for determining a bid-based advertisement ranking in order of advertisement unit price bid for an exposure ranking of the advertisement received from the advertiser; a client position confirmation module 208 for confirming information on a position of the client connected to a wired or wireless Internet; a distance-based advertisement ranking determination module 210 for reclassifying, if the position of the client is confirmed by the client position confirmation module 208, the advertisement ranking as a distance-based advertisement ranking by a distance from the client regardless of a bidding price by comparing the distance to an advertisement region provided when the advertisement is registered based on the position of the client; and a distance-bid combining advertisement ranking determination module 212 for finally determining, if the position of the connected client is confirmed by the client position confirmation module 208, a distance-bid combined advertisement ranking which combines distance and bidding by adding a bid-based advertisement ranking classified according to a bidding price determined through the bid-based advertisement ranking management module to a distance-based advertisement ranking classified by the distance from the client determined through the distance-based advertisement ranking determination module 210.

Preferably, the device further includes an advertisement exposure module 214 for exposing content of the advertisement re-determined through an advertisement exposure ranking determination module to the connected client.

Preferably, the device further includes an advertisement cost settlement module 216 for settling, if the advertisement is exposed to the client or the exposed advertisement is clicked, an advertisement execution cost from an account balance of the advertiser stored in an account balance DB 224.

Preferably, the advertiser management module 202 receives an advertisement cost settled when the advertisement is exposed or when the advertisement is clicked after the exposure from the advertiser and stores and manages the advertisement cost in an account balance DB 224.

Preferably, the content of the advertisement is any one of a keyword advertisement, a floating advertisement, a voice advertisement, a banner and an app advertisement exposing a home page URL of the advertiser and brief information on a company or a product.

Preferably, the content of the advertisement is classified according to a keyword.

Preferably, if there is a plurality of advertisers bidding a same amount or a maximum unit price as a bidding unit price of the advertisement, the bid-based advertisement ranking management module 206 compares account balances of the advertisers and determines the bid-based advertisement ranking in descending order of the account balances.

Preferably, the client position confirmation module 208 confirms the position of the client by confirming communication device number data of the connected client, confirms the position of the client based on information on a base station, or receives the position of the client from a communication company.

Preferably, the exposed advertisement information is exposed in a background screen of the client, an appl or web browser, a mobile web or a mobile app.

The device for managing an exposure ranking of an advertisement combined with a position of a client according to the present invention is effective in that an advertisement reasonable for an advertiser can be placed by adding a bid-based advertisement ranking determined in order of advertisement unit price by bidding to a distance-based advertisement ranking determined on the basis of a position of a connected client.

In addition, it is effective in that since a bid-based advertisement ranking according to bidding and a distance-based advertisement ranking according to a distance are combined, although the bid-based advertisement ranking of an advertisement is low, the advertisement can be exposed to a client at a high priority in a specific region.

In addition, it is effective in that since even an advertiser may also adjust a bid-based advertisement ranking according to a distance, an advertisement cost may be optimized with respect to the advertisement effect.

### BRIEF DESCRIPTION OF THE DRAWINGS

FIG. 1 is a view schematically showing a device for managing an exposure ranking of an advertisement combined with a position of a client according to the present invention.

FIG. 2 is a block diagram showing an advertisement server according to the present invention.

FIG. 3 is a flowchart illustrating a process of managing an exposure ranking of an advertisement combined with a position of a client according to the present invention.

### DETAILED DESCRIPTION OF THE INVENTION

A device for managing an exposure ranking of an advertisement combined with a position of a client of the present invention will be hereafter described in detail, with reference to the accompanying drawings.

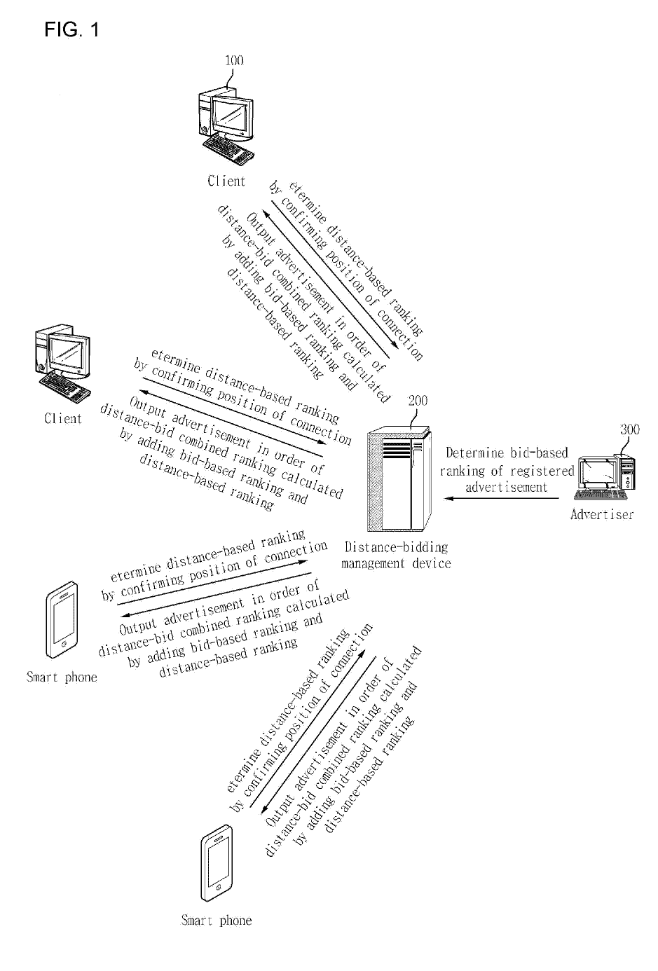

As shown in FIG. 1, the basic concept of the present invention is that since a distance-bidding device 200 which exposes an advertisement provided by an advertiser 300 to a connected client 100 adds a bid-based advertisement ranking determined in order of advertisement unit price by bidding for the advertisement received from the advertiser 300 to a distance-based advertisement ranking determined on the basis of a position of the connected client 100 such as a wired or wireless computer, a cellular phone, a smart phone, an IPTV, a set-top box, various terminals or the like, even an advertiser of a low bidding advertisement ranking may place an advertisement in a specific region.

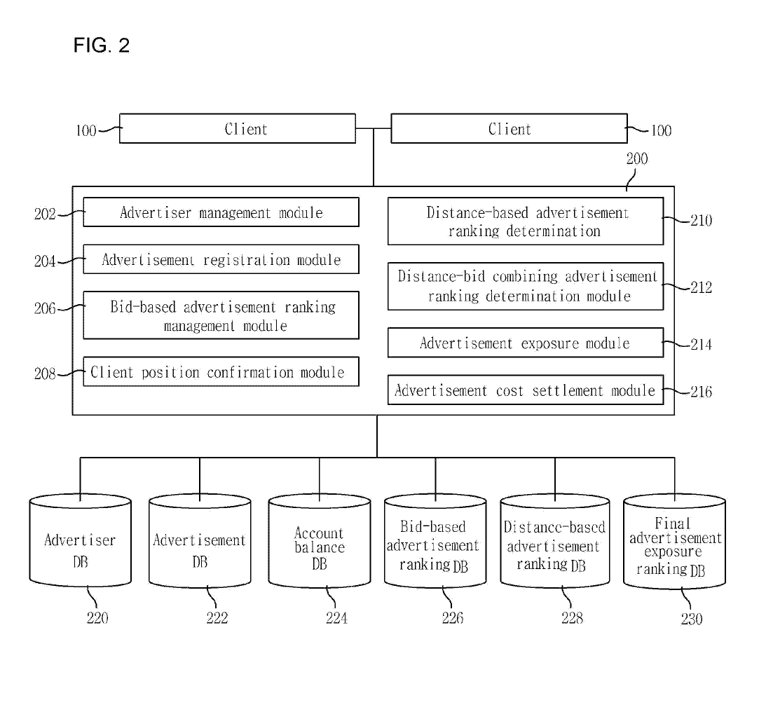

As shown in FIG. 2, the distance-bidding device 200 of the present invention includes an advertiser management module 202, an advertisement registration module 204, a bid-based advertisement ranking management module 206, a client position confirmation module 208, a distance-based advertisement ranking determination module 210, a distance-bid combining advertisement ranking determination module 212, an advertisement exposure module 214 and an advertisement cost settlement module 216.

The advertiser management module 202 receives information on the registration of an advertiser 300 who desires to place an advertisement to a client connected in a wired or wireless manner and stores and manages the information in an advertiser DB 220. At this point, information on the advertiser 300 is included in the advertiser DB 220 to provide various kinds of information to the advertiser. In addition, the advertiser management module 202 receives an advertisement cost settled when the advertisement is exposed or when the advertisement is clicked after the exposure from the advertiser and stores and manages the advertisement cost in an account balance DB 224. The advertiser management module 202 may notify the advertiser of information on the account balance of the advertiser at any time.

The advertisement registration module 204 receives information on a region of advertisement and content of the advertisement from the advertiser 300 and stores and manages the information in an advertisement DB 222. At this point, the content of the advertisement includes all of a keyword advertisement, a floating advertisement, a voice advertisement, a banner, an in-app advertisement, an app-in advertisement and the like exposing a home page URL of the advertiser and brief information on the company or a product, and the content of the advertisement is preferably classified according to a keyword.

The bid-based advertisement ranking management module 206 determines a bid-based advertisement ranking in order of advertisement unit price bid for an exposure ranking of the advertisement received from the advertiser 300, and if there is a plurality of advertisers bidding the same amount or a maximum unit price, the bid-based advertisement ranking management module 206 compares account balances of the advertisers and determines a bid-based advertisement ranking in descending order of the account balance and stores the bid-based advertisement ranking in a bid-based advertisement ranking DB 226. For example, as shown in Table 1, Mart A, Burger B, Chicken C, Café D, Pizza E, Car F, Cell phone G, Jean H, Dumpling I and Golf J may be determined in order of bidding for the unit price of an exposed advertisement. In addition, the bid-based advertisement ranking management module 206 may determine the bid-based advertisement ranking in descending order of a purchase conversion rate.

TABLE 1
Bid-based advertisement ranking

| | |
|---|---|
| 1 | Mart A |
| 2 | Burger B |
| 3 | Chicken C |
| 4 | Café D |
| 5 | Pizza E |
| 6 | Car F |
| 7 | Cell phone G |
| 8 | Jean H |
| 9 | Dumpling I |
| 10 | Golf J |

The client position confirmation module 208 confirms information on the position of a client 100 connected to a wired or wireless Internet. The client position confirmation module 208 confirms the position of the client 100 by confirming communication device number data of the connected client 100. The client position confirmation module 208 may be provided with the information on the position of the client 100 from a wired or wireless communication company.

If the position of the client 100 is calculated by the client position confirmation module 208, the distance-based advertisement ranking determination module 210 reclassifies the advertisement ranking as a distance-based advertisement ranking by a distance from the client 100 regardless of a bidding price by comparing the distance to an advertisement region provided when the advertisement is registered based on the position of the client 100 and stores the distance-based advertisement ranking in a distance-based advertisement ranking DB 300. For example, as shown in Table 2, the distance-based advertisement ranking may be determined by classifying an advertisement region into 100 m, 200 m, 300 m, 400 m or the like based on the position of the client 100.

TABLE 2
Distance-based advertisement ranking

| | |
|---|---|
| 1(100 m) | Chicken C |
| 1(100 m) | Car F |
| 2(200 m) | Jean H |
| 3(300 m) | Pizza E |
| 3(300 m) | Golf J |
| 4(400 m) | Burger B |
| 4(400 m) | Mart A |
| 4(400 m) | Café D |
| 5(500 m) | Cell phone G |
| 6(600 m) | Dumpling I |

If the position of the connected client 100 is confirmed by the client position confirmation module 208, the distance-bid combining advertisement ranking determination module 212 finally determines a distance-bid combined advertisement ranking which combines distance and bidding by adding a bid-based advertisement ranking classified according to a bidding price determined through the bid-based advertisement ranking management module to a distance-based advertisement ranking classified by the distance from the client 100 determined through the distance-based advertisement ranking determination module 210 and stores the determined advertisement ranking in a final advertisement exposure ranking DB 230. For example, as shown in Table 3, if the bid-based advertisement ranking and the distance-based advertisement ranking of an advertisement are determined, a distance-bid combined advertisement ranking may be determined in descending order of the combined ranking. That is, in the case of mart A, although the bid-based advertisement ranking is the first, the distance-based advertisement ranking is the fourth since the advertisement region is about 400 m away from the client, and the finally determined distance-bid combined advertisement ranking is the second since the score obtained by combining the first rank and the fourth rank is four points.

TABLE 3

| Bid-based | | Distance-based | | | | Re-determined | |
|---|---|---|---|---|---|---|---|
| advertisement | | advertisement | | Re-determined | | advertisement | |
| ranking | | ranking | | points | | ranking | |
| 1 | Mart A | 1 (100 m) | Chicken C | Mart A | 1 × 4 = 4 | 1 | Chicken C |
| 2 | Burger B | 1 (100 m) | Car F | Burger B | 2 × 4 = 8 | 2 | Mart A |
| 3 | Chicken C | 2 (200 m) | Jean H | Chicken C | 3 × 1 = 3 | 3 | Pizza E |
| 4 | Café D | 3 (300 m) | Pizza E | Café D | 4 × 4 = 16 | 4 | Burger B |
| 5 | Pizza E | 3 (300 m) | Golf J | Pizza E | 5 × 3 = 15 | 5 | Pizza E |
| 6 | Car F | 4 (400 m) | Burger B | Car F | 6 × 1 = 6 | 6 | Jean H |
| 7 | Cell phone G | 4 (400 m) | Mart A | Cell phone G | 7 × 5 = 35 | 7 | Café D |
| 8 | Jean H | 4 (400 m) | Café D | Jean H | 8 × 2 = 16 | 8 | Golf J |
| 9 | Dumpling I | 5 (500 m) | Cell phone G | Dumpling I | 9 × 6 = 54 | 9 | Cell phone G |
| 10 | Golf J | 6 (600 m) | Dumpling I | Golf J | 10 × 3 = 30 | 10 | Dumpling I |

The advertisement exposure module 214 exposes content of the advertisement re-determined through an advertisement exposure ranking determination module to the connected client 100. For example, information on an exposed advertisement may be exposed directly on the screen of the client 100, or when an appl is displayed, or on a web browser. In addition, when a plurality of advertisements is displayed together, they are displayed in descending order of ranking.

If the advertisement is exposed to the client 100 or the exposed advertisement is clicked, the advertisement cost settlement module 216 settles an advertisement execution cost from the account balance of the advertiser stored in the account balance DB 224.

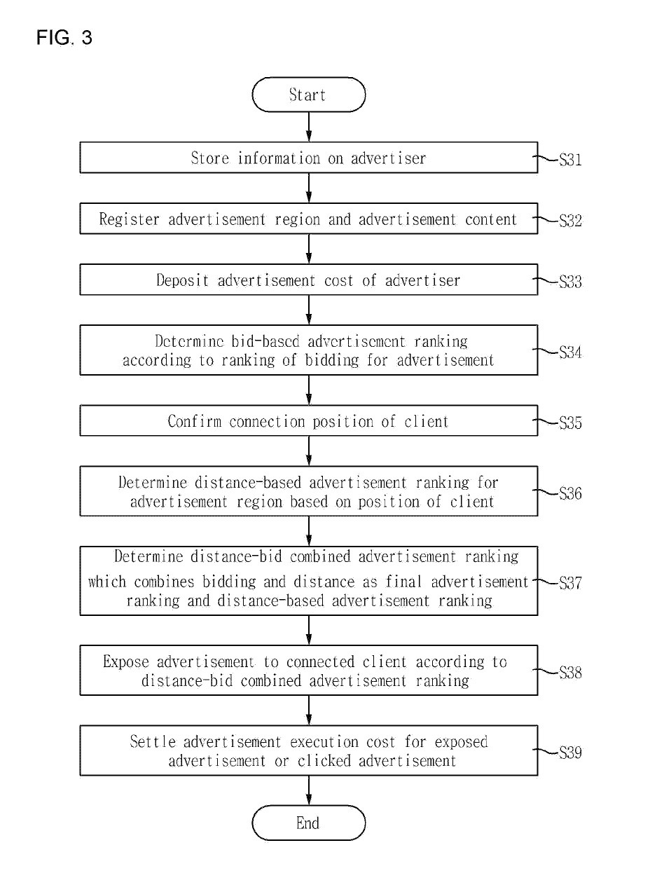

Hereinafter, a method of managing an exposure ranking of an advertisement combined with a position of a client according to the present invention will be described with reference to the flowchart shown in FIG. 3.

First, the advertisement registration module 204 receives information on an advertiser from the advertiser 300 and stores the information in the advertiser DB 220 (step S31), and the advertisement registration module 204 receives information on an advertisement displayed on the client 100 and information on a region of the advertisement and stores the information in the advertisement DB 222 (step S32). At this point, content of the advertisement registered by the advertiser includes all of a keyword advertisement, a floating advertisement, a voice advertisement, a banner and the like exposing a home page URL of the advertiser and brief information on the company or a product, and the content of the advertisement is preferably classified according to a keyword.

In addition, if the advertiser registering the advertisement deposits an amount used for advertisement cost, it is stored in the account balance DB 224 of the advertiser (step S33).

Meanwhile, the bid-based advertisement ranking management module 206 determines an exposure ranking of an advertisement in order of advertisement unit price bid for a registered advertisement by the advertiser and stores the exposure ranking in the bid-based advertisement ranking DB 226 (step S34). At this point, the advertisement unit price may be determined by betting on the ranking of exposure of the advertisement by the advertiser in a method of bidding, and when a maximum amount of a bidding unit price is set, account balances of advertisers are compared, and a priority of the advertisement may be determined in descending order of the account balances. In addition, when the advertisement is classified by keyword, the bid-based advertisement ranking may be determined in descending order of advertisement unit price by the keyword.

If the client 100 connects using a wired or wireless communication while the bid-based ranking of the advertisement is determined in this method, the client position confirmation module 208 confirms information on the position of the connected client 100 (step S35). Information on the position of the connected client 100 can be confirmed through the IP of the client, the position of a communication device to which the client is connected or the like.

If the position of the connected client 100 is confirmed, the distance-bid combining advertisement ranking determination module 212 re-determines the ranking of the advertisement received from the advertiser as a distance-based advertisement ranking by the distance from the position of the client 100 regardless of the bidding price and stores the distance-based advertisement ranking in the distance-based advertisement ranking DB 228 (step S36). For example, the ranking of the advertisement may be reclassified by the unit of 100 m, 200 m, 300 m, 400 m or the like based on the position of the client.

If the distance-based advertisement ranking is set based on the distance from the position of the client 100 through the procedure described above, the distance-bid combining advertisement ranking determination module 212 finally re-determines a distance-bid combined advertisement ranking which combines distance and bidding by adding a bid-based advertisement ranking classified according to a bidding price determined through the bid-based advertisement ranking management module to a distance-based advertisement ranking classified by the distance from the client 100 determined through the distance-based advertisement ranking determination module 210 and stores the determined advertisement ranking in the final advertisement exposure ranking DB 230 (step S37). At this point, the distance-bid combined advertisement ranking may be determined by awarding a score differentiated according to the bid-based advertisement ranking and the distance-based advertisement ranking.

If the distance-bid combined advertisement ranking is determined for the registered advertisement by the advertiser through the procedure described above, the advertisement exposure module 214 exposes the advertisement to the connected client 100 in descending order of the advertisement exposure ranking (step S38). At this point, when the exposed advertisement is text, a plurality of advertisements may be exposed together according to the ranking, and when one advertisement is displayed in a web page, like a floating advertisement or a full-page advertisement, an advertisement of the highest ranking is displayed.

Then, if the advertisement is exposed to the client 100 or the exposed advertisement is clicked, an advertisement execution cost is settled from the account balance of the advertiser stored in the account balance DB 224 (step S39).

Since an advertiser may place an advertisement based on a position of a connected client 100 through the procedure described above, even an advertiser of a low advertisement bidding unit price may place an advertisement in a region in which the advertiser desires to place an advertisement.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A device for managing an exposure ranking of an advertisement combined with a position of a client, the device comprising:
an advertiser management module (202) for receiving information on registration of an advertiser who desires to place an advertisement to a client (100) connected in a wired or wireless manner and storing and managing the information in an advertiser DB (220);
an advertisement registration module (204) for receiving information on a region of advertisement and content of the advertisement from the advertiser and storing and managing the information in an advertisement DB (222);
a bid-based advertisement ranking management module (206) for determining a bid-based advertisement ranking in order of advertisement unit price bid for an exposure ranking of the advertisement received from the advertiser;
a client position confirmation module (208) for confirming information on a position of the client connected to a wired or wireless Internet;
a distance-based advertisement ranking determination module (210) for reclassifying, if the position of the client is calculated by the client position confirmation module (208), the advertisement ranking as a distance-based advertisement ranking by a distance from the client regardless of a bidding price by comparing the distance to an advertisement region provided when the advertisement is registered based on the position of the client; and
a distance-bid combining advertisement ranking determination module (212) for finally determining, if the position of the connected client is confirmed by the client position confirmation module (208), a distance-bid combined advertisement ranking which combines distance and bidding by adding a bid-based advertisement ranking classified according to a bidding price determined through the bid-based advertisement ranking management module to a distance-based advertisement ranking classified by the distance from the client determined through the distance-based advertisement ranking determination module (210).

2. The device according to claim 1, further comprising an advertisement exposure module (214) for exposing content of the advertisement re-determined through an advertisement exposure ranking determination module to the connected client.

3. The device according to claim 1, further comprising an advertisement cost settlement module (216) for settling, if the advertisement is exposed to the client or the exposed advertisement is clicked, an advertisement execution cost from an account balance of the advertiser stored in an account balance DB (224).

4. The device according to claim 1, wherein the advertiser management module (202) receives an advertisement cost settled when the advertisement is exposed or when the advertisement is clicked after the exposure from the advertiser and stores and manages the advertisement cost in an account balance DB (224).

5. The device according to claim 1, wherein the content of the advertisement is any one of a keyword advertisement, a floating advertisement, a voice advertisement, a banner and an app advertisement exposing a home page URL of the advertiser and brief information on a company or a product.

6. The device according to claim 1, wherein the content of the advertisement is classified according to a keyword.

7. The device according to claim 1, wherein if there is a plurality of advertisers bidding a same amount or a maximum unit price as a bidding unit price of the advertisement, the bid-based advertisement ranking management module (206) compares account balances of the advertisers and determines the bid-based advertisement ranking in descending order of the account balances.

8. The device according to claim 1, wherein the client position confirmation module (208) confirms the position of the client by confirming communication device number data of the connected client, confirms the position of the client based on information on a base station, or receives the position of the client from a communication company.

9. The device according to claim 1, wherein the exposed advertisement information is exposed in a background screen of the client, an appl or web browser, a mobile web or a mobile app.

10. A method of managing an exposure ranking of an advertisement combined with a position of a client, the method comprising the steps of:
receiving information on an advertisement displayed on the client (100) and information on a region of the advertisement from an advertiser;
determining an exposure ranking of an advertisement in order of advertisement unit price bid for a registered advertisement by the advertiser and storing the exposure ranking as a bid-based advertisement ranking;
confirming, if the client (100) connects using a wired or wireless communication while the bid-based ranking of the advertisement is determined, information on the position of the connected client (100);
re-determining, if the position of the connected client (100) is confirmed, the ranking of the advertisement received from the advertiser as a distance-based advertisement ranking by the distance from the position of the client (100) regardless of the bidding price;
finally re-determining, if the distance-based advertisement ranking is set based on the distance from the position of the client (100), a distance-bid combined advertisement ranking which combines distance and bidding by adding a bid-based advertisement ranking classified according to a bidding price to a distance-based advertisement ranking classified by the distance from the client (100); and
exposing the advertisement to the connected client (100) in order of the distance-bid combined advertisement ranking.

11. The method according to claim 10, further comprising the step of settling, if the advertisement is exposed to the client (100) or the exposed advertisement is clicked, an advertisement execution cost.

12. The method according to claim 10, wherein when the advertisement is classified by keyword, the bid-based advertisement ranking is classified by the keyword.
